(19) United States
(12) Patent Application Publication
(10) Pub. No.: US 2021/0314991 A1
(43) Pub. Date: Oct. 7, 2021

(54) BUFFER STATUS REPORT TRANSMISSION IN A SEPARATE RESOURCE POOL FOR VEHICULAR COMMUNICATION

(71) Applicant: MediaTek Singapore Pte. Ltd., Singapore (SG)

(72) Inventors: Nathan Edward TENNY, San Jose, CA (US); Guan-Yu LIN, Hsinchu City (TW)

(21) Appl. No.: 17/266,174

(22) PCT Filed: Jan. 8, 2020
(86) PCT No.: PCT/US2020/012685

§ 371 Date: Feb. 5, 2021

Related U.S. Application Data
(60) Provisional application No. 62/790,595, filed on Jan. 10, 2019.

(51) Int. Cl. H04W 72/12; H04W 72/02; H04W 72/14; H04W 74/08; H04W 28/02

(52) U.S. Cl. CPC H04W 72/1284; H04W 72/1263; H04W 72/02; H04W 92/18; H04W 74/0816; H04W 28/0278; H04W 72/14

(57) ABSTRACT

Aspects of the disclosure provide a scheduled user equipment (UE) and a scheduling UE for wireless communication. The scheduled UE is configured to receive a configuration message of a resource pool. The configuration message indicates available sidelink resources of the resource pool for sidelink communications. The scheduled UE is further configured to select one or more of the available sidelink resources from the resource pool, and transmit, to the scheduling UE, a sidelink buffer status report (BSR) using the selected one or more sidelink resources. The scheduling UE is configured to determine a resource pool for sidelink communications, and indicate the resource pool to one or more scheduled UEs. The scheduling UE is further configured to receive, from one of the one or more scheduled UEs, a sidelink BSR in one or more available sidelink resources of the resource pool.

### INCORPORATION BY REFERENCE

This present disclosure claims the benefit of U.S. Provisional Application No. 62/790,595, “BUFFER STATUS REPORT TRANSMISSION IN A SEPARATE RESOURCE POOL FOR V2X” filed on Jan. 10, 2019, which is incorporated herein by reference in its entirety.

### TECHNICAL FIELD

The present disclosure relates to wireless communications, and specifically relates to sidelink resource allocation for sidelink communications.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Cellular based vehicle-to-everything (V2X) (e.g., LTE V2X or NR V2X) is a radio access technology developed by 3GPP to support advanced vehicular applications. In V2X, a direct radio link (referred to as a sidelink) can be established between two devices, for example, between two vehicles, between two mobile phones, or between one vehicle and one mobile phone. A sidelink can operate under the control of a cellular system. For example, a radio resource of a sidelink can be granted by a cellular system when the sidelink is within the coverage of the cellular system, or a user equipment (UE) can be authorized to select a radio resource autonomously within a pool of resources configured by the cellular system. Besides being granted by a cellular system, a sidelink can be granted by a UE. For example, a radio resource of a sidelink can be granted by a UE instead of a cellular system when the sidelink is out of the coverage of the cellular system. In addition, when a sidelink operates under the control of a cellular system, a UE can be authorized to grant radio resources to other UEs, either in or out of coverage of the cellular system.

### SUMMARY

Aspects of the disclosure provide a method for wireless communication. The method receives, at a scheduled UE, a configuration message of a first resource pool. The configuration message indicates available sidelink resources of the first resource pool for sidelink communications. The method selects one or more of the available sidelink resources from the first resource pool, and transmits, to a scheduling UE, a first sidelink buffer status report (BSR) using the selected one or more sidelink resources.

In an embodiment, the method receives, from the scheduling UE, a sidelink grant allocating one or more available sidelink resources of a second resource pool for the sidelink communications. The method can perform the sidelink communications using the allocated one or more available sidelink resources.

In an embodiment, the method determines whether the sidelink grant is received. When the sidelink grant is determined not to be received, the method transmits, to the scheduling UE, a second sidelink BSR.

In an embodiment, the method selects a transmission pattern for the first sidelink BSR. Based on the transmission pattern, the method transmits, to the scheduling UE, a second sidelink BSR. In an example, the transmission pattern includes a repetition time.

In an embodiment, the method receives the configuration message of the first resource pool from one of a base station (BS) and the scheduling UE.

In an embodiment, the method selects the one or more available sidelink resources from the first resource pool based on at least one of a random selection algorithm, a hash function, and a listen-before-talk operation.

In an embodiment, the first sidelink BSR includes at least one of (i) an identifier associated with the scheduled UE and (ii) an indication of at least one cast type of communication service.

Aspects of the disclosure further provide an apparatus for wireless communication. The apparatus, referred to as scheduled UE, includes processing circuitry that receives a configuration message of a first resource pool. The configuration message indicates available sidelink resources of the first resource pool for sidelink communications. The processing circuitry selects one or more of the available sidelink resources from the first resource pool, and transmits, to a scheduling UE, a first sidelink BSR using the selected one or more sidelink resources.

Aspects of the disclosure provide another method for wireless communication. The method determines, at a scheduling UE, a first resource pool for sidelink communications, and indicates the first resource pool to one or more scheduled UEs. From one of the one or more scheduled UEs, the method receives a first sidelink BSR in one or more available sidelink resources of the first resource pool.

In an embodiment, the method sends, to the one of the one or more scheduled UEs, a sidelink grant based at least in part on the first sidelink BSR in response to the first sidelink BSR. In an example, the sidelink grant is sent using one or more sidelink resources of a second resource pool.

In an embodiment, the method receives an indication of the first resource pool from a BS.

In an embodiment, the method receives an indication of one or more sidelink resources from a BS, and selects a subset of the one or more sidelink resources as the first resource pool.

In an embodiment, the first sidelink BSR includes at least one of (i) an identifier associated with the one of the one or more scheduled UEs and (ii) an indication of at least one cast type of communication service.

Aspects of the disclosure provide another apparatus for wireless communication. The apparatus, referred to as scheduling UE, includes processing circuitry that determines a first resource pool for sidelink communications, and indicates the first resource pool to one or more scheduled UEs. From one of the one or more scheduled UEs, the processing circuitry receives a first sidelink BSR in one or more available sidelink resources of the first resource pool.

Aspects of the disclosure further provide a non-transitory computer-readable medium which stores instructions implementing any one of a combination of the methods for wireless communication.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary scheduling procedure 100 for sidelink communication according to an embodiment of the disclosure;

FIG. 2 shows another scheduling procedure 200 of the sidelink communication according to an embodiment of the disclosure;

FIG. 3 shows a detailed procedure of FIG. 1 with a preconfigured pool for sidelink BSRs according to an embodiment of the disclosure;

FIG. 4 shows a detailed procedure of FIG. 2 with a preconfigured pool for sidelink BSRs according to an embodiment of the disclosure;

FIG. 5 shows an example of different pattern selection according to an embodiment of the disclosure;

FIG. 6 shows a flowchart outlining an exemplary process 600 according to embodiments of the disclosure;

FIG. 7 shows another flowchart outlining an exemplary process 700 according to embodiments of the disclosure;

FIG. 8 shows an exemplary BSR resource pool 800 according to embodiments of the disclosure;

FIGS. 9A and 9B show impacts of the system load (N, p) on optimal number of BSR transmission (r) according to embodiments of the disclosure;

FIGS. 10A-10C show impacts of the resource pool size on the success probability according to embodiments of the disclosure; and

FIG. 11 shows an exemplary apparatus according to embodiments of the disclosure.

### DETAILED DESCRIPTION OF EMBODIMENTS

Aspects of the disclosure provide methods and apparatuses for sidelink communication. In some embodiments, devices (e.g., vehicles, cell phones, infrastructure devices, street lights, and street signs) in a wireless communication network can perform communication directly without going through a base station (BS, such as eNB, gNB). The direct communication between the devices in the wireless communication network can be referred to as sidelink communication, and a direct radio link through which the direction communication is performed can be referred to as sidelink. The sidelink communication can include vehicle to vehicle (V2V) communication, vehicle to pedestrian (V2P) communication, vehicle to device (V2D) communication, user equipment (UE) to UE communication, cell phone to cell phone communication, device to device (D2D) communication, and the like. While UE to UE communication is used as examples in the present disclosure, the examples can be suitably modified for other sidelink communication scenarios, such as V2V communication, V2X communication, V2P communication, V2D communication, and the like.

Sidelink communication can be performed through one or more sidelink radio resources. In some embodiments (e.g., 3GPP design for V2X communication), a sidelink radio resource can be allocated by using a so-called “UE-assisted” resource allocation method, in which one UE assists or performs resource allocation for another UE. For example, a first UE (referred to as scheduling UE) can be responsible for allocating sidelink radio resources used by a second UE (referred to as scheduled UE). In such a scenario, the scheduled UE can send an indication to the scheduling UE when the scheduled UE has available data to be transmitted. For example, when the scheduled UE needs one or more sidelink radio resources for data transmission, the scheduled UE can send a resource request to the scheduling UE to request sidelink radio resources. In response to the resource request, the scheduling UE can send back a sidelink grant that allocates one or more sidelink radio resources to the scheduled UE.

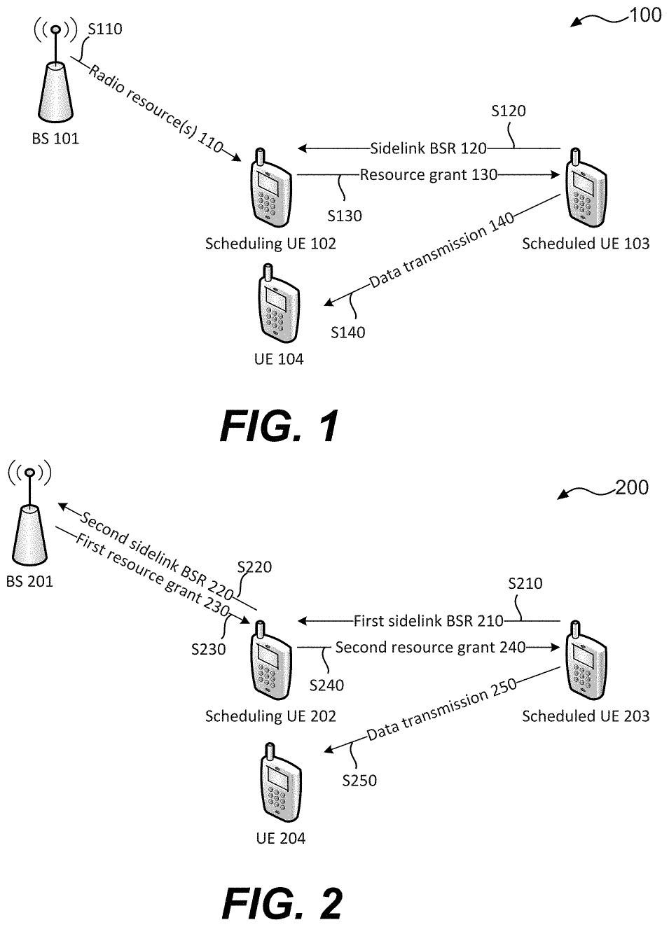

According to aspects of the disclosure, a resource request can be carried by a certain version of buffer status report (BSR) or equivalent information, which can indicate, e.g., the status of queues at a scheduled UE for one or more logical channels (LCs). Accordingly, in order to perform data transmission through sidelink communication, the scheduled UE can transmit a sidelink BSR or equivalent information to the scheduling UE to request a sidelink grant. To issue the sidelink grant, the scheduling UE can either process the sidelink BSR itself or forward the sidelink BSR to the BS. Both operations are referred to as scheduling procedure for sidelink communication and will be described in FIG. 1 and FIG. 2. It is noted that although BSR is used in the embodiments of the present disclosure, other equivalent information is also suitable for these embodiments.

FIG. 1 shows an exemplary scheduling procedure 100 for sidelink communication according to an embodiment of the disclosure. The scheduling procedure 100 includes four steps S110-S140 for a UE to perform data transmission on sidelink radio resources.

At step S110, a BS 101 can assign one or more sets of radio resources 110 to a scheduling UE 102. In an embodiment, the one or more sets of radio resources 110 can be assigned at the time of connection configuration, or in a subsequent reconfiguration. The one or more set of radio resources 110 can be sent over Physical Downlink Shared Channel (PDSCH) and/or Physical Downlink Control Channel (PDCCH). The BS 101 can assign one set of radio resources 110 to the scheduling UE 102. For example, the BS 101 can assign a resource pool to the scheduling UE 102.

In an embodiment, the BS 101 can assign multiple sets of radio resources 110 to the scheduling UE 102. In an example, the multiple sets of radio resources 110 can be separated and configured with the scheduling UE 102 for different cast types of services, such as unicast, groupcast, and/or broadcast services. In such an example, a cast type (e.g., unicast, groupcast, or broadcast) of a concerned service(s) can be indicated in a sidelink BSR. Based on the cast type indicated in the sidelink BSR, the scheduling UE 102 can allocate radio resources from the correct set for the concerned service(s).

At step S120, a scheduled UE 103 sends a sidelink BSR 120 to the scheduling UE 102 to request a sidelink resource grant. In an embodiment, the sidelink BSR 120 can be sent over one or more sidelink radio resources, such as Physical Sidelink Shared Channel (PSSCH). The transmission of the sidelink BSR may use various protocols; for instance, the sidelink BSR may be a medium access control (MAC) control element (CE). The sidelink BSR 120 can include identification information allowing the scheduling UE 102 to identify the scheduled UE 103, since multiple scheduled UEs may have been configured to send BSRs in the same set of radio resources.

At step S130, in response to the sidelink BSR 120, the scheduling UE 102 sends a sidelink resource grant 130 to the scheduled UE 103. In an embodiment, the sidelink resource grant 130 can be sent over Physical Sidelink Control Channel (PSCCH). Alternatively, the sidelink resource grant 130 can be sent over PSSCH using a higher-layer protocol, for instance, a MAC protocol.

In some embodiments, the sidelink resource grant 130 can grant one or more sidelink resources (e.g., PSSCH) for the scheduled UE 103 to perform data transmission through sidelink communication. In an embodiment, the one or more sidelink resources are selected from the one or more sets of radio resources 110 that were previously issued by the BS 101 to the scheduling UE 102 in step S110. In an embodiment, the scheduling UE 102 may determine contents of the sidelink resource grant 130 based on a scheduling algorithm that takes into account contents of the sidelink BSR 120. For example, a size of the sidelink resource grant 130 may be determined based on the amount of data currently queued at the scheduled UE 103, as indicated by the sidelink BSR 120.

At step S140, after receiving the sidelink resource grant 130, the scheduled UE 103 can use the granted sidelink radio resources (e.g., PSSCH) to perform data transmission 140 with another UE (e.g., UE 104). It is noted that a role of the UE 104 is not restricted by the disclosure in any way. The UE 104 may or may not be involved in UE-assisted resource allocation. In some embodiments, when the UE 104 is involved in UE-assisted resource allocation, the UE 104 can be a scheduled UE and/or a scheduling UE. Alternatively, when the UE 104 is not involved in UE-assisted resource allocation (e.g., the UE 104 is not configured for any role in the UE-assisted resource allocation), the UE 104 may just monitor the resource pool for transmissions from the UE 103.

FIG. 2 shows another scheduling procedure 200 of the sidelink communication according to an embodiment of the disclosure. The scheduling procedure 200 includes five steps S210-S250 for a UE to perform data transmission on sidelink radio resources.

At step S210, a scheduled UE 203 sends a first sidelink BSR 210 to a scheduling UE 202 to request a sidelink resource grant. In an embodiment, the first sidelink BSR 210 can be sent over one or more sidelink radio resources (e.g., PSSCH). In an embodiment, the first sidelink BSR 210 can include identification information allowing the scheduling UE 202 to identify the scheduled UE 203, since multiple scheduled UEs may have been configured to send BSRs in the same set of radio resources.

At step S220, the scheduling UE 202 sends a second sidelink BSR 220 to a BS 201. In an embodiment, the second sidelink BSR 220 may be produced by forwarding the first sidelink BSR 210 to the BS201, for example, over Physical Uplink Shared Channel (PUSCH) and/or Physical Uplink Control Channel (PUCCH). In an embodiment, the second sidelink BSR 220 may be constructed by the scheduling UE 202 based on the contents of the first sidelink BSR 210.

At step S230, the BS 201 processes the second sidelink BSR 220 and sends a first sidelink resource grant 230 to the scheduling UE 202. In an embodiment, the first sidelink resource grant 230 can be sent to the scheduling UE 202 over PDCCH. In an embodiment, the first sidelink resource grant 230 can be generated based on a scheduling algorithm that takes into account contents of the second sidelink BSR 220. For example, a size of the first sidelink resource grant 230 may be determined based on the amount of data currently queued at the scheduled UE 203, as indicated by the second sidelink BSR 220.

At step S240, the scheduling UE 202 sends a second sidelink resource grant 240 to the scheduled UE 203. The second sidelink resource grant 240 can grant one or more sidelink resources (e.g., PSSCH) for the scheduled UE 203 to perform data transmission through sidelink communication. In an embodiment, the second sidelink resource grant 240 may be produced by forwarding the first sidelink resource grant 230 to the scheduled UE 203, for example, over PSCCH. In an embodiment, the second sidelink resource grant 240 can be constructed by the scheduling UE 202 based on the contents of the first sidelink resource grant 230.

At step S250, the scheduled UE 203 can use the granted sidelink radio resources (e.g., PSSCH) to perform data transmission with another UE (e.g., UE 204). It is noted that a role of the UE 204 is not restricted by the disclosure in any way. The UE 204 may or may not be involved in UE-assisted resource allocation. In some embodiments, when the UE 204 is involved in UE-assisted resource allocation, the UE 204 can be a scheduled UE and/or a scheduling UE. Alternatively, when the UE 204 is not involved in UE-assisted resource allocation (e.g., the UE 204 is not configured for any role in the UE-assisted resource allocation), the UE 204 may just monitor the resource pool for transmissions from the UE 203.

It is noted that, in either FIG. 1 or FIG. 2, the initial (or first) sidelink BSR 120 (or 210) is sent over a sidelink radio resource(s) from the scheduled UE 103 (or 203) to the scheduling UE 102 (or 202). That is, the sidelink BSR transmission is also performed through sidelink communication, thus one or more sidelink radio resources should be first allocated for the sidelink BSR transmission before sidelink BSR transmission is performed.

According to aspects of the disclosure, the sidelink radio resources for the sidelink BSR transmission can be obtained from a common resource pool (e.g., BSR resource pool) that is established for the purpose of performing the sidelink BSR transmission. The use of the common resource pool can allow a statistical multiplexing among the scheduled UEs so that the usage efficiency of the radio resources is improved compared to dedicated allocation of sidelink BSR resources to individual UEs.

In some embodiments, the common resource pool can be established by a BS (e.g., the BS 101 in FIG. 1 or the BS 201 in FIG. 2) or by a scheduling UE (e.g., the scheduling UE 102 in FIG. 1 or scheduling UE 202 in FIG. 2) to be available to multiple scheduled UEs (e.g., the scheduled UE 103 in FIG. 1 or the scheduled UE 203 in FIG. 2).

In alternative embodiments, the common resource pool can be provided by a scheduling UE (e.g., the scheduling UE 102 or 202) to be shared among all scheduled UEs (e.g., the scheduled UE 103 or 203) in a groupcast service.

In further embodiments, the common resource pool can be provided by a BS (e.g., the BS 101 or 201) to all UEs in a service area of the BS. For example, a BS can indicate a BSR resource pool in a system information block (SIB) or a similar broadcast transmission that is available to all UEs in a service area of the B S, and any UE that finds itself in the role of a scheduled UE may transmit a sidelink BSR (e.g., the sidelink BSR 120 in FIG. 1 or the sidelink BSR 210 in FIG. 2) over a sidelink radio resource(s) from the BSR resource pool.

In an embodiment, when a scheduled UE (e.g., the scheduled UE 103 or 203) is out of a service area of a BS (e.g., the BS 101 or 201), a scheduling UE (e.g., the scheduling UE 102 or 202) in the service area of the BS can indicate the common resource pool (e.g., BSR resource pool) to the scheduled UE that is out of the service of the BS. For example, when a SIB is used by the BS to indicate a BSR resource pool and contain pool information of the BSR resource pool, the scheduling UE in the service of the BS can forward a copy of the SIB to the scheduled UE that is out of the service of the BS.

According to aspects of the disclosure, a scheduled UE (e.g., the scheduled UE 103 or 203) can autonomously select radio resources within the common resource pool to transmit a sidelink BSR (e.g., the sidelink BSR 120 or 210). The autonomous resource selection may use various algorithms such as random selection, listen-before-talk (LBT), selection based on a hash function, and so on, either alone or in combination.

In an embodiment, the sidelink BSR can contain an identifier associated with the scheduled UE, so that other entities such as the scheduling UE and/or the BS can identify the scheduled UE requesting a sidelink grant. Further, the BSR resource pool may be structured based on the services used by scheduled UEs. For example, the radio resources in the BSR pool can be separated to be used for different services, such as unicast, groupcast, and/or broadcast. In such an example, information of the service(s) for which resources are requested can be indicated along with the sidelink BSR, and the scheduling UE and/or the BS can then take this information into account in formulating an appropriate grant of sidelink radio resources.

According to aspects of the disclosure, the common resource pool (also referred to as preconfigured pool) is preconfigured to the scheduled UE (e.g., the scheduled UE 103 or 203), so that the scheduled UE can transmit sidelink BSRs in the correct radio resources based on the pre-configuration information of the common resource pool.

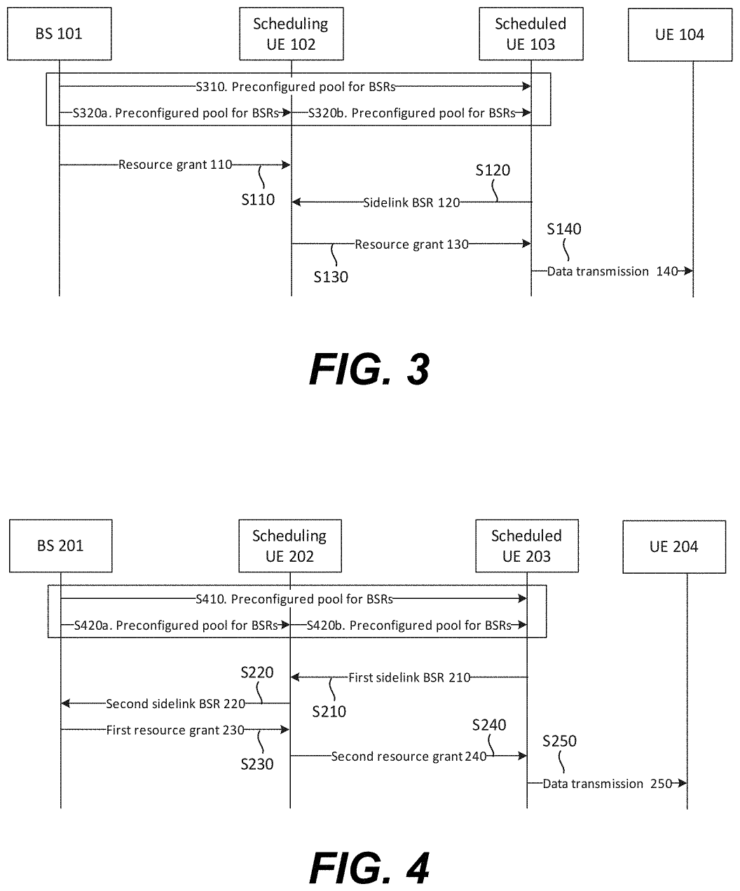

FIG. 3 shows a detailed procedure of FIG. 1 with a preconfigured pool for sidelink BSRs. In FIG. 3, the preconfigured pool (e.g., BSR pool) is determined by the BS 101 and can be preconfigured in two ways.

In a first way, when the scheduled UE 103 is in the coverage of the BS 101, the preconfigured pool can be preconfigured by a direct transmission (e.g., in an SIB) from the BS 101 to the scheduled UE 103, as shown at step S310. The preconfigured pool may subsequently be used by the scheduled UE 103, for example, when the scheduled UE 103 is out of the coverage of the BS 101.

In a second way, when the scheduled UE 103 is out of the coverage of the BS 101, the preconfigured pool can be preconfigured by a forwarded transmission from the BS 101 to the scheduled UE 103. That is, the preconfigured pool is sent from the BS 101 to the scheduling UE 102, as shown at step S320a, and then is forwarded to the scheduled UE 103, as shown at step S320b.

In some embodiments, the preconfigured pool can also be preconfigured to the scheduling UE 102, so that the scheduling UE 102 can listen to the corresponding radio resources.

At step S110 of FIG. 3, a set of radio resources 110 (e.g., a pool or a grant) to be used for data scheduling is configured by the BS 101 to the scheduling UE 102. The set of radio resources 110 includes the sidelink radio resources that the scheduling UE 102 is permitted to “re-grant” to one or more scheduled UEs (e.g., scheduled UE 103). The set of radio resources 110 may be referred to as a pool that can be shared by multiple scheduling UEs, or as a grant sent to one scheduling UE specifically.

In some embodiments, the set of radio resources 110 may include multiple subsets with different characteristics. For example, specific sets of resources can be used respectively for unicast, groupcast, and/or broadcast services. The configuration of the radio resources for data scheduling may use signaling of various protocols (e.g. an RRC protocol).

At step S120 of FIG. 3, the scheduled UE 103 transmits the sidelink BSR 120 over the sidelink radio resource of the preconfigured pool to the scheduling UE 102. The sidelink BSR 120 can indicate the state of the transmitting buffers of the scheduled UE 103. It is noted that scheduling request (SR) transmission is not required herein, because the radio resources to transmit the sidelink BSR are already available to the scheduled UE 103 from the pre-configuration procedure (e.g., step 310 and/or step 320).

The sidelink BSR 120 may contain an identifier corresponding to the scheduled UE 103. The sidelink BSR 120 may contain an indication of the condition of one or more buffers corresponding to one or more logical channels (LCs) over the sidelink. If the set of radio resources 110 at step S110 includes multiple subsets, for example, to be used for services with different cast types, the sidelink BSR 120 may indicate information about the service that allows the scheduling UE 102 to select the correct subset to draw resources from. For example, the sidelink BSR 120 may indicate if the concerned service(s) is/are unicast, groupcast, or broadcast. Such an indication may be explicit (e.g., a field in the sidelink BSR 120 with different values for unicast, groupcast, and broadcast) or implicit (e.g., different resources within the preconfigured pool could be used for unicast, groupcast, and broadcast services).

The sidelink BSR 120 is transmitted in resources selected from the preconfigured pool that was configured at step S310 or S320. The selection of resources is autonomous on the part of the scheduled UE 103, but may use various methods such as random selection, a hash function, LBT, etc., alone or in combination. For example, the scheduled UE 103 may select resources at random, then perform an LBT operation to attempt to confirm that the selected resources are vacant before using them. The transmission of the sidelink BSR 120 may use various protocols (e.g. a MAC protocol).

At step S130 of FIG. 3, the scheduling UE 102 transmits the sidelink resource grant 130 to the scheduled UE 103. The sidelink resource grant 130 allocates sidelink radio resources from the set of radio resources 110 for data scheduling to the scheduled UE 103 for data transmission. The allocated sidelink radio resources may be determined by the scheduling UE 102 based at least in part on the contents of the sidelink BSR 120. The signaling of the sidelink resource grant 130 may use various protocols (e.g. a PHY or MAC protocol). The sidelink resource grant 130 may be indicated by sidelink control information (SCI) transmission.

At step S140 of FIG. 3, the scheduled UE 103 transmits data on the granted sidelink radio resources that were indicated by the sidelink resource grant 130 at step S130. The data can be transmitted to the UE 104.

The allocation of the common resource pool for BSR transmission can also be used in conjunction with the scheduling method of FIG. 2. A flow for this combination is shown in FIG. 4.

Similar to FIG. 3, the pre-configuration procedure of the common resource pool (also referred to as preconfigured pool) in FIG. 4 can proceed in either of two ways.

In a first way, when the scheduled UE 203 is in the coverage of the BS 201, the preconfigured pool (e.g., BSR pool) can be preconfigured to the scheduled UE 203 by a direct transmission (e.g., in a SIB) from the BS 201, as shown at step S410. The preconfigured pool may subsequently be used by the scheduled UE 203, for example, when the scheduled UE 203 is out of the coverage of the BS 201.

In a second way, when the scheduled UE 203 is out of the coverage of the BS 201, the preconfigured pool can be preconfigured by a forwarded transmission from the BS 201 to the scheduled UE 203. That is, the preconfigured pool is sent from the BS 201 to the scheduling UE 202, as shown at step S420a, and then is forwarded to the scheduled UE 203, as shown at step S420b.

In some embodiments, the preconfigured pool can also be preconfigured to the scheduling UE 202, so that the scheduling UE 202 can listen to the corresponding radio resources.

At step S210 of FIG. 4, the scheduled UE 203 transmits the first sidelink BSR 210 over the sidelink radio resource(s) to the scheduling UE 202. The first sidelink BSR 210 indicates the state of the transmitting buffers of the scheduled UE 203. It is noted that the SR transmission is not required herein, because the radio resources for transmitting the first sidelink BSR 210 are already available to the scheduled UE 203 due to the pre-configuration procedure (e.g., step 410 and/or step 420).

In some embodiments, the first sidelink BSR 210 may contain an identifier corresponding to the scheduled UE 203. The first sidelink BSR 210 may contain an indication of the condition of one or more buffers corresponding to one or more LCs on the sidelink. The first sidelink BSR 210 can be transmitted over sidelink radio resources selected from the preconfigured pool that was configured at step S410 or step S420.

In some embodiments, the selection of radio resources is autonomous on the part of the scheduled UE 203, but may use various methods such as random selection, a hash function, LBT, etc., alone or in combination. For example, the scheduled UE 203 may select resources at random, and then perform an LBT operation to attempt to confirm that the selected resources are vacant before using them. The transmission of the first sidelink BSR 210 may use various protocols (e.g., MAC protocol).

At step S220 of FIG. 4, the scheduling UE 202 transmits the second sidelink BSR 220 to the BS 201. In an embodiment, the second sidelink BSR 220 may be produced by forwarding the first sidelink BSR 210. In an embodiment, the second sidelink BSR 220 may be constructed by the scheduling UE 202 based on the contents of the first sidelink BSR 210. The transmission of the second sidelink BSR 220 may use various protocols (e.g., MAC protocol).

At step S230 of FIG. 4, the BS 201 transmits to the scheduling UE 202 the first sidelink grant 230. The first sidelink grant 230 may be determined by a scheduling algorithm at the BS 201, based at least in part on the contents of the second sidelink BSR 220. The signaling of the first sidelink grant 230 may use various protocols (e.g., PHY protocol).

At step S240 of FIG. 4, the scheduling UE 202 transmits to the scheduled UE 203 the second sidelink grant 240 over the sidelink radio resources. In an embodiment, the second sidelink grant 240 may be produced by forwarding the first sidelink grant 230. In an embodiment, the second sidelink grant 240 may be constructed by the scheduling UE 202 based on the contents of the first sidelink grant 230. The transmission of the second sidelink grant 240 may use various protocols (e.g., PHY or MAC protocol). The second sidelink grant 240 may be indicated by an SCI transmission.

At step S250 of FIG. 4, the scheduled UE 203 transmits data 250 over the radio resources that were indicated by the second sidelink grant 240 at step S240. The data 250 can be transmitted to the UE 204.

According to aspects of the disclosure, the preconfigured pool can also be determined by the scheduling UE (e.g., the scheduling UE 102 in FIG. 1 or the scheduling UE 202 in FIG. 2). The preconfigured pool can be a subset of a pool previously indicated to the scheduling UE by the BS (e.g., the BS 101 in FIG. 1 or the BS 201 in FIG. 2). For example, the scheduling UE may originate the pre-configuration information. The pre-configuration can allow the scheduled UE to transmit sidelink BSRs in the designated resource pool (e.g., the BSR pool). In an embodiment, the scheduling UE is informed of the BSR pool so that the scheduling UE can know where to listen. The scheduling UE may be informed of the BSR pool by transmission from the BS as shown in step S320a or S420a. The transmissions to configure the BSR pool may use various protocols (e.g., an RRC protocol). The transmissions may be broadcast transmissions such as one or more SIBs, or they may be dedicated signaling transmissions directed to a specific UE.

In one embodiment, the BSR pool may be first indicated to the scheduling UE by a SIB sent as a broadcast transmission on the Uu interface from the BS, and subsequently indicated to the scheduled UE by the scheduling UE on the sidelink, for example, using broadcast, groupcast, or unicast transmission.

It is noted that there may be a risk of collision if two or more scheduled UEs select the same or overlapping resources in the BSR pool for their sidelink BSR transmissions. The risk can be mitigated by dimensioning the BSR pool appropriately for the number of UEs using the BSR pool and the expected density of traffic, but it cannot readily be eliminated. Accordingly, mechanisms may be needed for recovering from collision. As one example, a supervisory mechanism could be used in which a scheduled UE that does not receive a sidelink grant within some time period after transmitting a sidelink BSR will retransmit the sidelink BSR.

According to aspects of the disclosure, to avoid sidelink BSR transmission failure due to collision, the scheduled UE (e.g., the scheduled UE 103 or 203) can send multiple transmissions of the sidelink BSR, e.g. using a blind repetition scheme, with a selected transmission pattern. As one example, the transmission pattern might include a selected periodicity for repetitions of the sidelink BSR. The pattern selection can provide a dimension of orthogonality between different scheduled UEs, in that if two scheduled UEs select the same radio resources for their initial sidelink BSR transmissions, the two scheduled UEs can select different radio resources for subsequent repetitions of their sidelink BSR transmissions. That is, if the two scheduled UEs select different transmission patterns for repetitions of their sidelink BSR transmissions, their subsequent sidelink BSR transmissions may not collide.

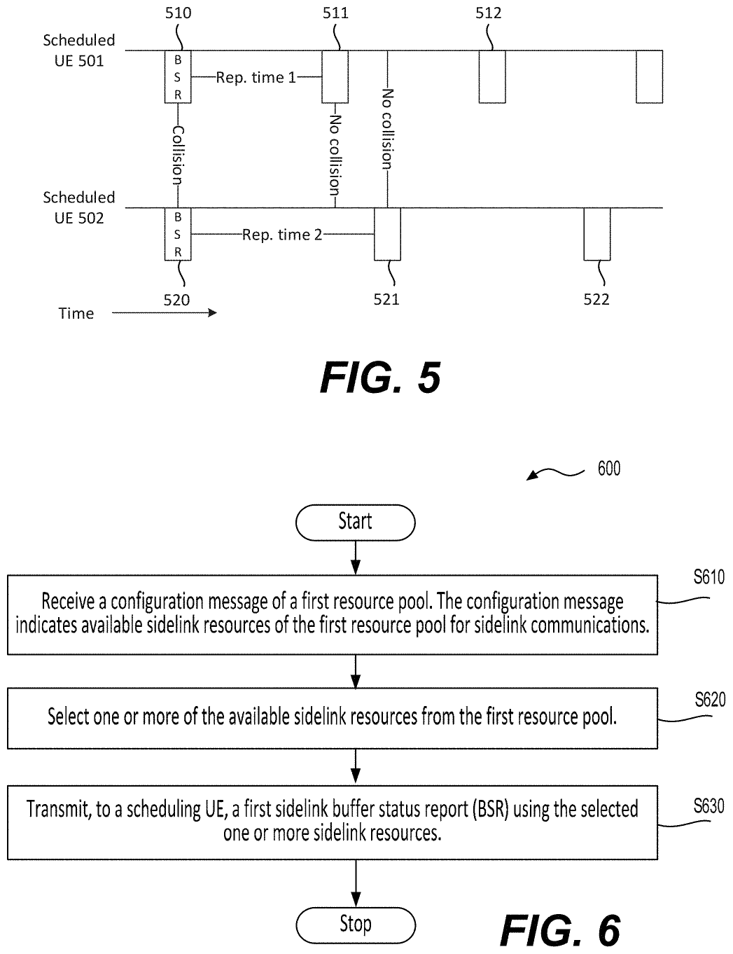

FIG. 5 shows an example of different pattern selection. In FIG. 5, a scheduled UE 501 and a scheduled UE 502 both need to transmit sidelink BSRs. In their respective first sidelink BSR transmissions 510 and 520, both select the same radio resources at the same time, resulting in a collision. However, the scheduled UE 501 and the scheduled UE 502 select different transmission patterns. As shown in FIG. 5, different transmission patterns include different repetition times (indicated as “Rep. time 1” and “Rep. time 2”). As a result of the different repetition times, the second and subsequent repetitions (e.g., the BSR transmissions 511-512 and 521-522) of the sidelink BSR transmissions may not collide.

Besides the illustrated approach of de-confliction in the time dimension, other schemes can be considered, such as hopping the repetitions in the frequency dimension, transmitting multiple copies of the sidelink BSR at the same time in different frequency resources, and so on.

FIG. 6 shows a flowchart outlining an exemplary process 600 according to embodiments of the disclosure. In various embodiments, the process 600 is executed by processing circuitry, such as the processing circuitry in the scheduled UE 103 or 203. In some embodiments, the process 600 is implemented in software instructions, thus when the processing circuitry executes the software instructions, the processing circuitry performs the process 600.

The process 600 may generally start at step S610, where the process 600 receives a configuration message of a first resource pool. The configuration message indicates available sidelink resources of the first resource pool for sidelink communications. For example, the sidelink resources are available for autonomous selection by a UE for sidelink communication. Then the process 600 proceeds to step S620.

At step S620, the process 600 selects one or more of the available sidelink resources from the first resource pool. Then the process 600 proceeds to step S630.

At step S630, the process 600 transmits, to a scheduling UE, a first sidelink buffer status report (BSR) using the selected one or more sidelink resources. Then the process 600 terminates.

In an embodiment, the process 600 receives, from the scheduling UE, a sidelink grant allocating one or more available sidelink resources of a second resource pool for the sidelink communications. The process 600 can perform the sidelink communications using the allocated one or more available sidelink resources.

In an embodiment, the process 600 determines whether the sidelink grant is received. When the sidelink grant is determined not to be received, the process 600 transmits, to the scheduling UE, a second sidelink BSR.

In an embodiment, the process 600 selects a transmission pattern for the first sidelink BSR. Based on the transmission pattern, the process 600 transmits, to the scheduling UE, a second sidelink BSR. In an example, the transmission pattern includes a repetition time.

In an embodiment, the process 600 receives the configuration message of the first resource pool from one of a base station (BS) and the scheduling UE.

In an embodiment, the process 600 selects the one or more available sidelink resources from the first resource pool based on at least one of a random selection algorithm, a hash function, and a listen-before-talk operation.

In an embodiment, the first sidelink BSR includes at least one of (i) an identifier associated with the scheduled UE and (ii) an indication of at least one cast type of communication service.

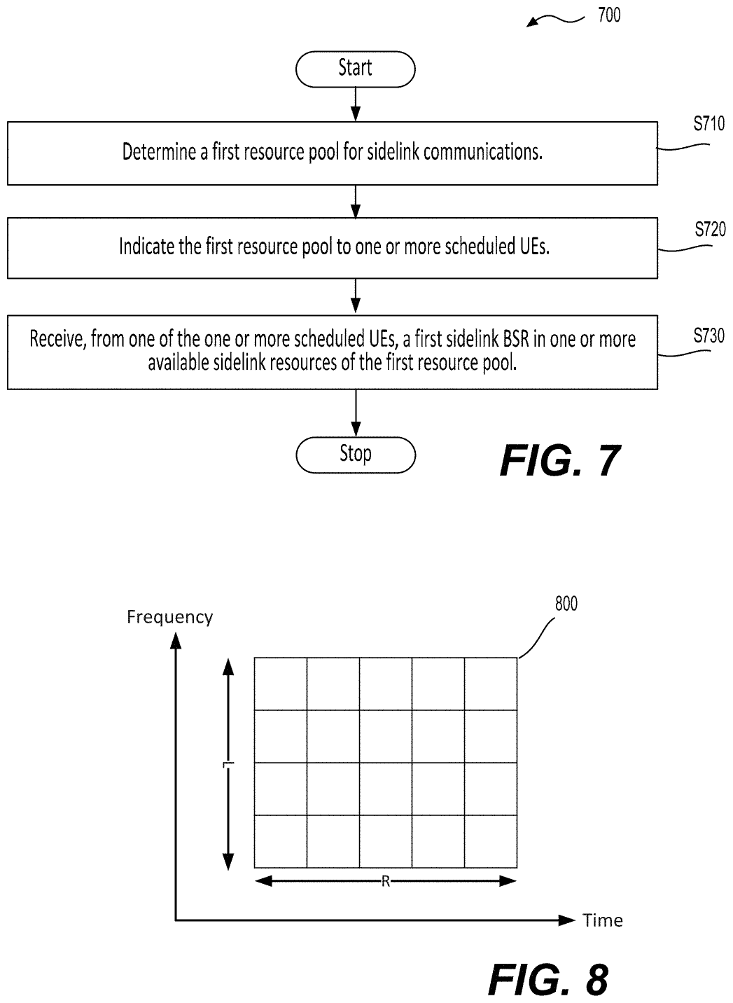

FIG. 7 shows another flowchart outlining an exemplary process 700 according to embodiments of the disclosure. In various embodiments, the process 700 is executed by processing circuitry, such as the processing circuitry in the scheduling UE 102 or 202. In some embodiments, the process 700 is implemented in software instructions, thus when the processing circuitry executes the software instructions, the processing circuitry performs the process 700.

The process 700 may generally start at step S710, where the process 700 determines a first resource pool for sidelink communications. Then the process 700 proceeds to step S720.

At step S720, the process 700 indicates the first resource pool to one or more scheduled UEs. Then the process 700 proceeds to step S730.

At step S730, the process 700 receives, from one of the one or more scheduled UEs, a first sidelink BSR in one or more available sidelink resources of the first resource pool.

In an embodiment, the process 700 sends, to the one of the one or more scheduled UEs, a sidelink grant based at least in part on the first sidelink BSR in response to the first sidelink BSR. In an example, the sidelink grant is sent using one or more sidelink resources of a second resource pool.

In an embodiment, the process 700 receives an indication of the first resource pool from a BS.

In an embodiment, the process 700 receives an indication of one or more sidelink resources from a BS, and selects a subset of the one or more sidelink resources as the first resource pool.

In an embodiment, the first sidelink BSR includes at least one of (i) an identifier associated with the one of the one or more scheduled UEs and (ii) an indication of at least one cast type of communication service.

According to aspects of the disclosure, a Hybrid Automatic Repeat Request (HARQ) process can be applied to the BSR transmission. Accordingly, HARQ information, such as HARQ process identification (ID), redundancy version (RV), and new data indicator (NDI), may be transmitted along with PUSCH for the BSR transmission. The BSR can include an identifier for a scheduled UE so that the scheduled UE can be identified when sending the BSR. To avoid BSR transmission failure due to collision, the scheduled UE can send BSRs based on a selected BSR transmission pattern. The BSR may indicate whether the requested resource is for unicast or groupcast.

It is noted that if the collision rate of the BSR transmission is high, the latency performance may be degraded. Accordingly, a scheduling UE can send an SCI to schedule multiple scheduled UEs with separate BSR resources in the common resource pool (also referred to as BSR resource pool). When a scheduled UE receives the SCI for group-based uplink (UL) grant and the scheduled UE is indicated in the SCI for BSR transmission, the scheduled UE can send BSRs in the indicated BSR resources if the scheduled UE has pending BSRs. Additionally, other UEs should not transmit BSR on the BSR resources that are already assigned to the scheduled UE.

According to aspects of the disclosure, the BSR resource pool can be configured to be activated and/or deactivated.

In some embodiments, in a service-oriented resource configuration, if the scheduled UE has no extremely latency critical data for transmission, or if the system load (collision probability) is relatively low, the scheduling UE may configure the scheduled UE with BSR resource pool rather than reserved resource (e.g., UE-specific configured grant); if the scheduled UE has latency critical data for transmission, the scheduling UE may configure the scheduled UE with UE-specific configured grant rather than the BSR resource pool.

In some embodiments, for resource adaptation due to configuration change, if the BS reconfigures a smaller set of resources for sidelink transmission (for instance, a smaller resource pool), the scheduling UE may decide to activate the BSR resource pool to improve resource efficiency while maintaining latency performance; if the BS reconfigures a larger set of resources for sidelink transmission (for instance, a larger resource pool), the scheduling UE may decide to configure each scheduled UE with a UE-specific configured grant. Then, there is no strong need for them to use the BSR resource pool which is shared by other UEs.

According to aspects of the disclosure, the BSR resource pool can be configured with an RRC message. Activation/deactivation may use signaling of a lower layer. For example, the scheduling UE can use L1 signaling (SCI) for indication of activation/deactivation. Upon receiving the activation/deactivation indication in SCI, the scheduled UE can reply to the scheduling UE with a confirmation MAC control element (CE).

In some related art on the Uu interface, the BSR transmission can be operated in a scenario that the scheduled UE uses a UE-specific UL resource to send BSR. That is, if a MAC protocol data unit (PDU) including the BSR MAC CE is not successfully received, the BS knows the scheduled UE sending the BSR and can provide a grant for MAC PDU retransmission.

In an embodiment, when a collision occurs to the BSR transmission, the scheduling UE cannot decode the BSR to know the scheduled UE ID. Without scheduled UE ID, it is unclear how the scheduling UE triggers HARQ retransmission. An alternative solution is to use an SR-like BSR transmission in such a case. For example, a counter can be used to count the number of BSR transmission until the maximum number is reached, and a timer can be used to control the spacing time of neighboring BSR transmission. The scheduled UE may transmit multiple BSR repetitions for each BSR counter increase. For example, whenever BSR counter is added by 1, the scheduled UE is allowed to send multiple BSR in the BSR resource pool(s).

According to aspects of the disclosure, the scheduled UE can be informed of the successful BSR reception. That is, the scheduled UE can know that the BSR is successfully received by the scheduling UE.

In an embodiment, if the scheduled UE receives a grant (e.g., sidelink grant) from the scheduling UE, the scheduled UE can send BSR again in the grant and then cancel the pending BSR.

In an embodiment, the scheduling UE provides an indication in SCI for the next UL grant to inform the scheduled UE of the successful BSR reception.

In an embodiment, the scheduling UE provides downlink (DL) MAC CE to confirm the successful BSR reception.

In an embodiment, a new Radio Network Temporary Identifier (RNTI) can be used to inform the scheduled UE of the successful BSR reception.

In an example, a new RNTI can be used for BSR per UE. That is, the RNTI is UE specific. Specifically, after the scheduled UE sends a BSR, the scheduled UE monitors its RNTI for the BSR. If the scheduled UE receives a PSCCH transmission addressed to its BSR RNTI, then the scheduled UE succeeds in BSR transmission.

In another example, a new RNTI can be used for BSR per BSR resource. That is, the RNTI is BSR resource specific. Specifically, after the scheduled UE sends a BSR over a resource, the scheduled UE monitors the BSR RNTI corresponding to the resource for BSR transmission. If the scheduled UE receives a PSCCH addressed to the BSR RNTI and the corresponding PSSCH includes UE ID, the scheduled UE succeeds in BSR transmission.

FIG. 8 shows an exemplary BSR resource pool 800 according to embodiments of the disclosure. The BSR resource pool 800 has a size of L×R, where L represents a number of resource units in the frequency domain and R represents a number of resource units in the time domain. In addition, a number of UE sharing the BSR resource pool 800 can be represented by N, the BSR transmission rate can be represented by p, and a number of BSR transmissions in the BSR resource pool when the scheduled UE decides to send BSR can be represented by r.

It is assumed that (i) the scheduled UE can send at most 1 BSR in one slot, and will send r BSRs in R slots in the BSR resource pool; (ii) the scheduling UE can receive multiple BSRs from different scheduled UEs at the same slot; (iii) the scheduled UE uniformly selects r among R slot for BSR transmission; and (iv) if a slot is selected, the scheduled UE uniformly selects 1 among L resource units in the selected slot for BSR transmission.

Based on the above assumption, the success probability can be defined as the probability that the scheduled UE can send BSR successfully in the BSR resource pool, which is equal to the probability that the scheduled UE has at least one non-collided BSR in the BSR resource pool. The success probability (Ps) can be expressed as

$${P}_{S} = {\sum }_{i = 1}^{r} {( - 1 )}^{i + 1} ( \begin{matrix}r \\ i\end{matrix} ) {( 1 - p + p * p ( i ) )}^{N - 1}$$

where

$$p ( i ) = {\sum }_{k = 0}^{i} \frac{( \begin{matrix}i \\ k\end{matrix} ) ( \begin{matrix}R - i \\ r - k\end{matrix} )}{( \begin{matrix}R \\ r\end{matrix} )} {( \frac{L - 1}{L} )}^{k}$$

is the probability that the i resource units selected by the scheduled UE are not selected by another UE for BSR transmission.

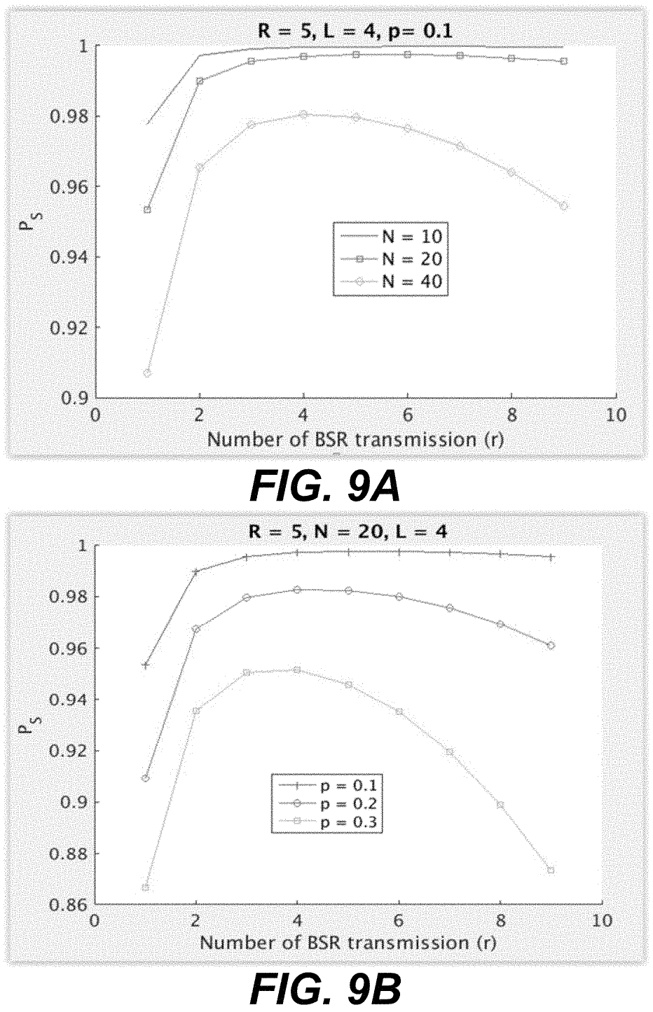

FIGS. 9A and 9B show impacts of the system load metrics (N, p) on optimal number of BSR transmission (r). It can be seen that as the system load (N or p) increases, the number of BSR repetitions to reach the maximized successful probability is reduced.

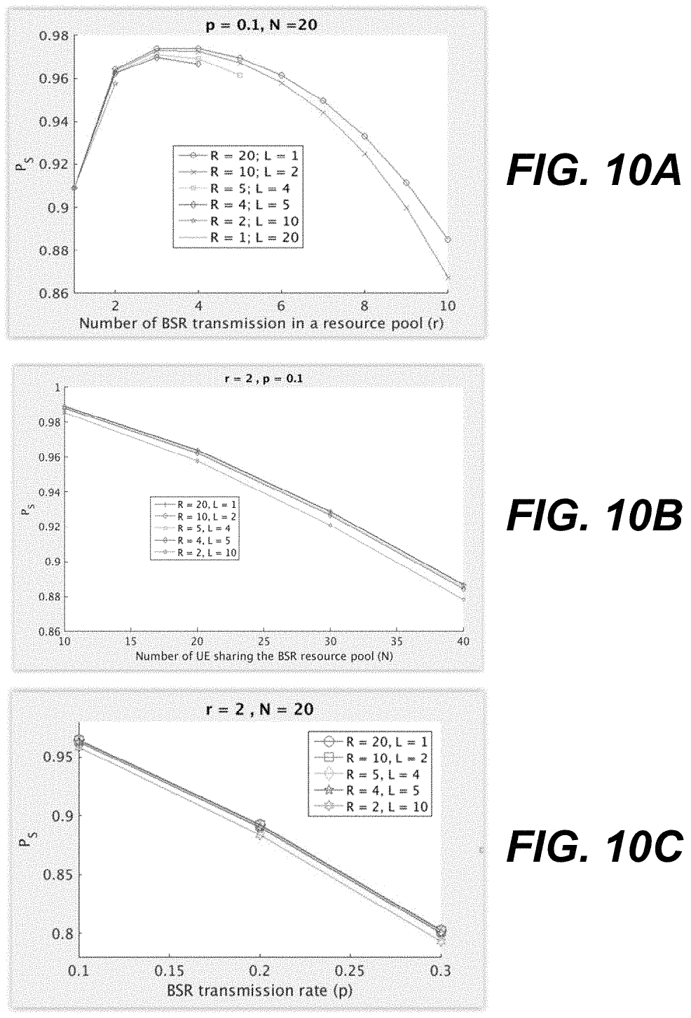

FIGS. 10A-10C show impacts of the resource pool size on the success probability. It can be seen that given the same size of BSR resource pool, the configuration with larger L (frequency domain) can have slightly worse Ps than the configuration with larger R (time domain). It is due to the assumption that the scheduled UE can transmit at most one BSR in a slot. Therefore, larger L means that more resource cannot be selected at the same time, which means less resource selection flexibility and therefore causes worse success probability. It also can be seen that, in different scenarios, when given fixed LxR value, the Ps performance of different (L, R) combinations are very similar. This means the scheduling UE should configure larger frequency domain resource to reduce BSR latency since the Ps degradation is limited.

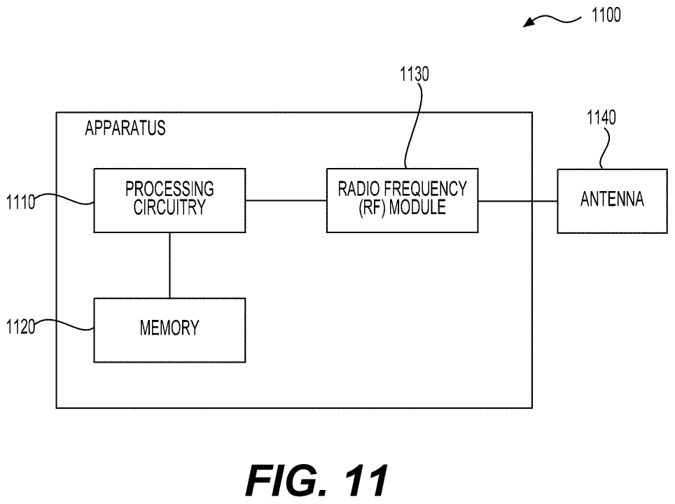

FIG. 11 shows an exemplary apparatus 1100 according to embodiments of the disclosure. The apparatus 1100 can be configured to perform various functions in accordance with one or more embodiments or examples described herein. Thus, the apparatus 1100 can provide means for implementation of techniques, processes, functions, components, systems described herein. For example, the apparatus 1100 can be used to implement functions of the scheduled UE 103 or 203, or the scheduling UE 102 or 202 in various embodiments and examples described herein. The apparatus 1100 can include a general purpose processor or specially designed circuits to implement various functions, components, or processes described herein in various embodiments. The apparatus 1100 can include processing circuitry 1110, a memory 1120, a radio frequency (RF) module 1130, and an antenna 1140.

In various examples, the processing circuitry 1110 can include circuitry configured to perform the functions and processes described herein in combination with software or without software. In various examples, the processing circuitry 1110 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1110 can be a central processing unit (CPU) configured to execute program instructions to perform various functions and processes described herein. Accordingly, the memory 1120 can be configured to store program instructions. The processing circuitry 1110, when executing the program instructions, can perform the functions and processes. The memory 1120 can further store other programs or data, such as operating systems, application programs, and the like. The memory 1120 can include a read only memory (ROM), a random access memory (RAM), a flash memory, a solid state memory, a hard disk drive, an optical disk drive, and the like.

The RF module 1130 receives a processed data signal from the processing circuitry 1110 and converts the data signal to a wireless signal that is then transmitted via the antenna 1140, or vice versa. The RF module 1130 can include a digital to analog convertor (DAC), an analog to digital converter (ADC), a frequency up convertor, a frequency down converter, filters and amplifiers for reception and transmission operations. The RF module 1130 can include multi-antenna circuitry for beamforming operations. For example, the multi-antenna circuitry can include an uplink spatial filter circuit, and a downlink spatial filter circuit for shifting analog signal phases or scaling analog signal amplitudes. Each of the antenna panels 840 and 850 can include one or more antenna arrays.

The apparatus 1100 can optionally include other components, such as input and output devices, additional or signal processing circuitry, and the like. Accordingly, the apparatus 1100 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for wireless communication, the method comprising:
receiving, at a scheduled user equipment (UE), a configuration message of a first resource pool, the configuration message indicating available sidelink resources of the first resource pool for sidelink communications;
selecting one or more of the available sidelink resources from the first resource pool; and
transmitting, to a scheduling UE, a first sidelink buffer status report (BSR) using the selected one or more sidelink resources.

2. The method of claim 1, further comprising:
receiving, from the scheduling UE, a sidelink grant allocating one or more available sidelink resources of a second resource pool for the sidelink communications; and
performing the sidelink communications using the allocated one or more available sidelink resources.

3. The method of claim 2, further comprising:
determining, at the scheduled UE, whether the sidelink grant is received; and
transmitting, to the scheduling UE, a second sidelink BSR when the sidelink grant is determined not to be received.

4. The method of claim 1, further comprising:
selecting, at the scheduled UE, a transmission pattern for the first sidelink BSR; and
transmitting, to the scheduling UE, a second sidelink BSR based on the transmission pattern.

5. The method of claim 4, wherein the transmission pattern includes a repetition time.

6. The method of claim 1, wherein the receiving includes:
receiving the configuration message of the first resource pool from one of a base station (BS) and the scheduling UE.

7. The method of claim 1, wherein the selecting includes:
selecting the one or more available sidelink resources from the first resource pool based on at least one of a random selection algorithm, a hash function, and a listen-before-talk operation.

8. The method of claim 1, wherein the first sidelink BSR includes at least one of (i) an identifier associated with the scheduled UE and (ii) an indication of at least one cast type of communication service.

9. A method for wireless communication, the method comprising:
determining, at a scheduling user equipment (UE), a first resource pool for sidelink communications;
indicating, to one or more scheduled UEs, the first resource pool; and
receiving, from one of the one or more scheduled UEs, a first sidelink buffer status report (BSR) in one or more available sidelink resources of the first resource pool.

10. The method of claim 9, further comprising:
in response to the first sidelink BSR, sending, to the one of the one or more scheduled UEs, a sidelink grant based at least in part on the first sidelink BSR.

11. The method of claim 10, wherein the sidelink grant is sent using one or more sidelink resources of a second resource pool.

12. The method of claim 9, wherein the determining includes:
receiving an indication of the first resource pool from a base station (BS).

13. The method of claim 9, wherein the determining includes:
receiving an indication of one or more sidelink resources from a BS; and
selecting a subset of the one or more resources as the first resource pool.

14. The method of claim 9, wherein the first sidelink BSR includes at least one of (i) an identifier associated with the one of the one or more scheduled UEs and (ii) an indication of at least one cast type of communication service.

15. An apparatus, comprising processing circuitry configured to:
receive a configuration message of a first resource pool, the configuration message indicating available sidelink resources of the first resource pool for sidelink communications;
select one or more of the available sidelink resources from the first resource pool; and
transmit a first sidelink buffer status report (BSR) using the selected one or more sidelink resources.

16. The apparatus of claim 15, wherein the processing circuitry is further configured to:
receive a sidelink grant allocating one or more available sidelink resources of a second resource pool for the sidelink communications; and
perform the sidelink communications using the allocated one or more available sidelink resources.

17. The apparatus of claim 16, wherein the processing circuitry is further configured to:
determine whether the sidelink grant is received; and
transmitting a second sidelink BSR when the sidelink grant is determined not to be received.

18. The apparatus of claim 15, wherein the processing circuitry is further configured to:
select a transmission pattern for the first sidelink BSR; and
transmit a second sidelink BSR based on the transmission pattern.

19. The apparatus of claim 15, wherein the processing circuitry is further configured to:
receive the configuration message of the first resource pool from one of a base station (BS) and the scheduling UE.

20. The apparatus of claim 15, wherein the processing circuitry is further configured to:
select the one or more available sidelink resources from the first resource pool based on at least one of a random selection algorithm, a hash function, and a listen-before-talk operation.
